(19) United States
(12) Patent Application Publication
(10) Pub. No.: US 2025/0153558 A1
(43) Pub. Date: May 15, 2025

(54) COOLING WATER MODULE COMPRISING COOLING WATER MANIFOLD

(71) Applicant: Hanon Systems, Daejeon (KR)

(72) Inventors: Seong Woo Jeong, Daejeon (KR); Jungbum Choi, Daejeon (KR); Gwang Ok Ko, Daejeon (KR)

(21) Appl. No.: 18/838,263

(22) PCT Filed: Jan. 6, 2023
(86) PCT No.: PCT/KR2023/000333

§ 371 Date: Aug. 14, 2024

(30) Foreign Application Priority Data
Mar. 17, 2022 (KR) 10-2022-0033171

(51) Int. Cl. B60K 11/02

(52) U.S. Cl. CPC B60K 11/02

(57) ABSTRACT

The present invention relates to a coolant module including a coolant manifold applied to a vehicle, and more particularly, to a coolant module including a coolant manifold, in which the coolant manifold is configured by integrating a reservoir tank and a coolant flow path, and the coolant module is configured by mounting heat exchange components in the coolant manifold.

### TECHNICAL FIELD

The present invention relates to a coolant module including a coolant manifold applied to a vehicle, and more particularly, to a coolant module including a coolant manifold, in which the coolant manifold is configured by integrating a reservoir tank and a coolant flow path, and the coolant module is configured by mounting heat exchange components in the coolant manifold.

### BACKGROUND ART

An electric or hybrid vehicle is equipped with power electronic (PE) components including a motor, an inverter, an on-board charger (OBC), and the like. In addition, the electric or hybrid vehicle is equipped with a battery configured to provide electric power to the PE components.

Because the PE component and the battery generate heat while operating, the PE component and the battery need to be essentially cooled to protect the components and ensure durability. To this end, the electric or hybrid vehicle is equipped with a water-cooled PE cooling system for cooling the PE components and a water-cooled battery cooling system for cooling the battery.

Because the PE components and the battery are different in temperature ranges in main operating regions, i.e., the PE component operates at a relatively higher temperature than the battery, separate cooling systems are required for the PE components and the battery. Therefore, a PE cooling circuit for cooling the PE component by circulating a coolant through the PE component and a battery cooling circuit for cooling the battery by circulating a coolant through the battery are separately provided.

FIG. 1 is a view illustrating a cooling structure system for an electric vehicle in the related art. As illustrated, separate reservoir tanks R1 and R2 are independently provided for respective cooling circuits in order to operate separate cooling circuits. As described above, the electric vehicle in the related art is equipped with two reservoir tanks R1 and R2 used for the respective cooling circuits. However, it is difficult to mount the two reservoir tanks R1 and R2 in a narrow engine room, and the number of constituent elements increases, which causes a problem of an increase in manufacturing costs. In addition, the increase in number of constituent elements increases the weight, the increase in time required to mount the reservoir tanks degrades the productivity, and there is an inconvenience of having to perform maintenance separately on the respective cooling circuits.

### DOCUMENT OF RELATED ART

Patent Document 1: Korean Patent Application Laid-Open No. 10-2020-0031907 (published on Mar. 25, 2020)

### DISCLOSURE

### Technical Problem

The present invention has been made in an effort to solve the above-mentioned problem, and an object of the present invention is to provide a coolant module including a coolant manifold, in which the coolant manifold is configured by integrating a reservoir tank and a coolant flow path, and the coolant module is configured by mounting heat exchange components in the coolant manifold, such that hoses or pipes may be excluded or a piping length may be shortened by integrating components that constitute a cooling system, thereby achieving miniaturization and weight reduction and reducing the number of components and the number of assembling processes.

### Technical Solution

A coolant module according to an example of the present invention may include: a coolant manifold, in which the coolant manifold includes: a base plate having a plate shape: a flow path plate coupled to one surface of the base plate and having a coolant flow path in which a coolant flows; and a reservoir tank provided at one side of the base plate and having therein a hollow structure to store the coolant.

The reservoir tank may be formed by coupling a first tank part and the base plate.

The base plate may include a second tank part made by concavely recessing a predetermined region of the base plate, and the first tank part and the second tank part may define one reservoir tank.

A degree to which the first tank part protrudes may be larger than a degree to which the second tank part protrudes.

An internal volume surrounded by the first tank part may be larger than an internal volume surrounded by the second tank part.

An internal space of the reservoir tank may be divided into two or more spaces by a partition wall.

At least one through portion, which is formed through the base plate, may be formed in the base plate.

At least one through-hole, which is formed through the base plate and communicates with the coolant flow path in the flow path plate, may be formed in the base plate.

At least some of the through-holes may be formed at a lower side of the reservoir tank and communicate with an internal space of the reservoir tank.

At least one coolant inlet/outlet pipe, through which the coolant is introduced and discharged, may be provided on the base plate, and the coolant pipe may communicate with at least one of the through-holes and communicate with the coolant flow path in the flow path plate.

At least one coolant inlet/outlet pipe, in which the coolant flow path in the flow path plate extends to allow the coolant to be introduced or discharged, may be provided on the flow path plate.

At least one coolant inlet/outlet port, which penetrates an outer surface of the flow path plate and communicates with the coolant flow path in the flow path plate to allow the coolant to be introduced or discharged, may be formed in the flow path plate.

The flow path plate may include: a first unit flow path plate having a first coolant flow path therein; and a second unit flow path plate having a second coolant flow path therein, and the first coolant flow path and the second coolant flow path may be separated from each other.

A mounting structure, on which a heat exchange component is mounted, may be provided on at least one of the base plate and the flow path plate.

The coolant module may further include: heat exchange components and a coolant control module mounted in the coolant manifold in which the coolant flows.

The coolant control module may include: at least one coolant pump: a coolant valve; and a controller configured to control the coolant pump and the coolant valve.

The heat exchange components may include a chiller and a condenser.

The flow path plate may be coupled to a rear surface of the base plate, the coolant control module may be mounted at a front side of the coolant manifold by means of a mounting structure provided on the base plate, and the chiller and the condenser may be mounted at a rear side of the coolant manifold by means of a mounting structure provided on the flow path plate.

The coolant control module may communicate directly with the coolant flow path in the flow path plate through a through-hole that is formed through the base plate and communicates with the coolant flow path, and the chiller and the condenser may communicate directly with the coolant flow path in the flow path plate through a coolant inlet/outlet port that penetrates an outer surface of the flow path plate and communicates with the coolant flow path to allow the coolant to be introduced or discharged.

### Advantageous Effects

According to the present invention, hoses or pipes may be excluded or a piping length may be shortened by integrating the components that constitute the cooling system, thereby achieving the miniaturization and weight reduction and reducing the number of components of the cooling system and the number of assembling processes.

In addition, the coolant inlet or outlet may be freely configured by the coolant manifold, which may improve a degree of freedom of the assemblability. Further, the reservoir tank may be integrated with the manifold, which may improve the effect of reducing the packaging and costs.

In addition, the internal space of the reservoir tank may be divided into two spaces, and the coolant flow path of the manifold may be formed as two coolant flow paths separated from each other while corresponding to the two spaces, such that the PE cooling circuit and the battery cooling circuit may be configured only by using the single coolant module, thereby further improving the packaging properties.

### DESCRIPTION OF DRAWINGS

FIG. 1 is a view illustrating a cooling structure system for an electric vehicle in the related art.

FIG. 2 is a front view illustrating a coolant manifold according to an example of the present invention when viewed from the front side.

FIG. 3 is a rear view of FIG. 2 when viewed from the rear side.

FIG. 4 is a side view of FIG. 2 when viewed from the right side.

FIG. 5 is a front perspective view of FIG. 2 when viewed from the front right side.

FIG. 6 is a front view illustrating a base plate according to the example of the present invention when viewed from the front side.

FIG. 7 is a rear perspective view of FIG. 6 when viewed from the rear side.

FIG. 8 is a view illustrating a flow path plate according to the example of the present invention.

FIG. 9 is a view for explaining a reservoir tank according to the example of the present invention.

FIG. 10 is a view illustrating a first tank part.

FIG. 11 is a view illustrating a second tank part.

FIG. 12 is a front view illustrating a coolant module according to the example of the present invention when viewed from the front side.

FIG. 13 is a rear view of FIG. 12 when viewed from the rear side.

FIGS. 14 and 15 are views for explaining a flow of a coolant in the coolant module according to the example of the present invention, in which FIG. 14 is a front view illustrating the coolant module when viewed from the front side, and FIG. 15 is a rear view illustrating the coolant module when viewed from the rear side.

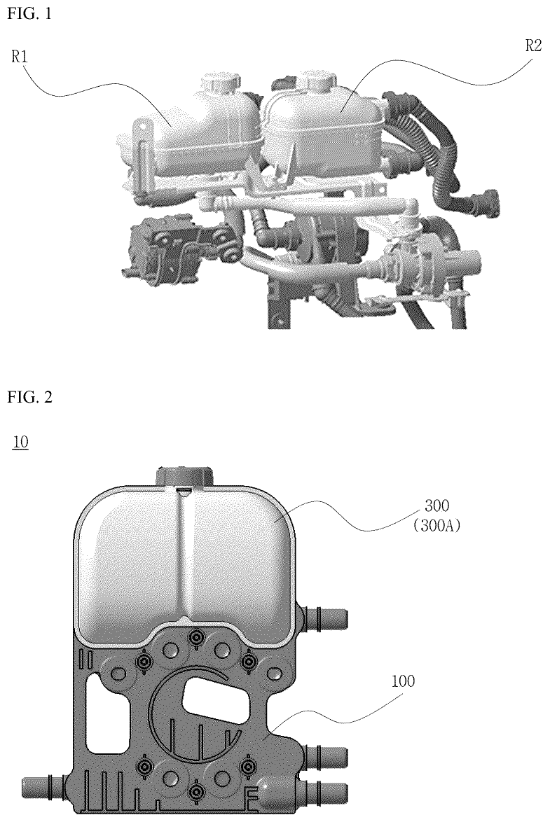

### MODE FOR INVENTION

Hereinafter, the present invention will be described with reference to the accompanying drawings.

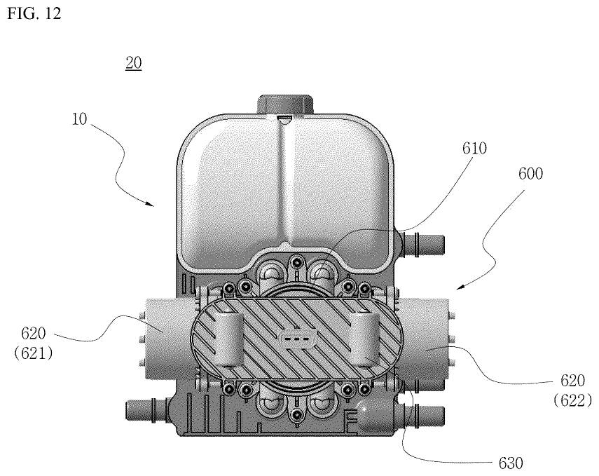

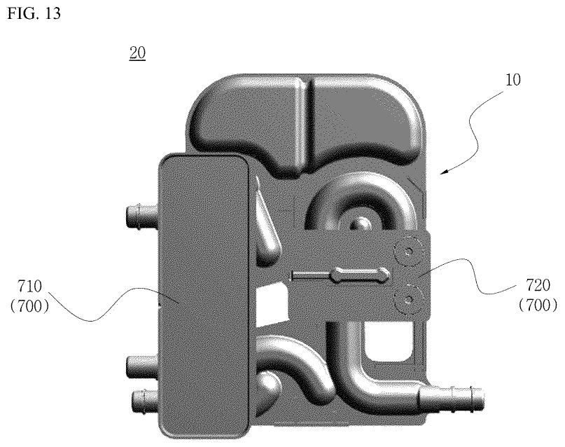

FIG. 12 is a front view illustrating a coolant module according to the example of the present invention when viewed from the front side, FIG. 13 is a rear view of FIG. 12 when viewed from the rear side. A coolant module 20 of the present invention broadly includes a coolant manifold 10, and a coolant control module 600 and heat exchange components 700 mounted in the coolant manifold 10.

The coolant control module 600 may broadly include a coolant valve 610, a coolant pump 620, and a controller 630. The coolant valve 610, the coolant pump 620, and the controller 630 may be integrated. The coolant valve 610 may be a multi-way switching valve and configured to switch a transfer direction of a coolant. The coolant pump 620 pumps the coolant. The controller 630 may include a PCB on which electronic elements are mounted, and the controller 630 may control an operation of the coolant valve 610 and an operation of the coolant pump 620. The coolant pump 620 may be provided as one or more coolant pumps including a first coolant pump 621 and a second coolant pump 622, for example.

The heat exchange components 700 may be various types of heat exchange components applicable to a vehicle cooling system. The components 700 of the present invention may include a condenser 710 and a chiller 720. The condenser 710 refers to a coolant-cooled condenser, i.e., a heat exchanger configured to condense a gaseous refrigerant to a liquid refrigerant by using the coolant. The chiller 720 refers to a heat exchanger configured to remove heat from the liquid refrigerant by using the coolant.

Further, the coolant manifold 10 may provide a coolant flow path, through which the coolant may flow, and also provide a support structure to which the heat exchange components may be mounted and coupled.

That is, the coolant module 20 of the present invention is made by collecting and integrating heat exchange components in a cooling system in the related art, in which a reservoir tank, a coolant pump, a coolant valve, and the like are independently mounted in a vehicle and the components are connected by hoses to constitute a cooling circuit, into a single coolant module by means of the coolant manifold 10.

First, the coolant manifold 10 of the present invention will be described in detail.

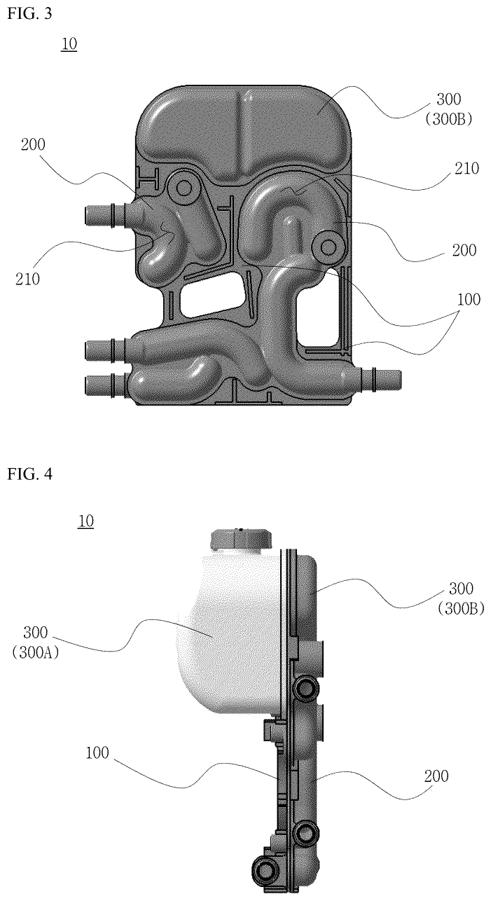

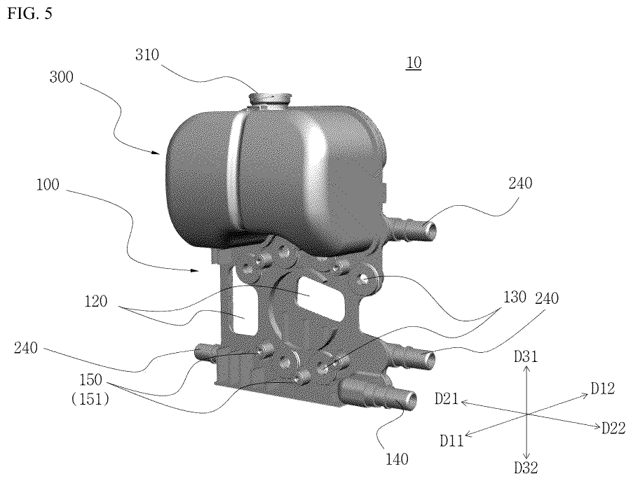

FIG. 2 is a front view illustrating the coolant manifold according to the example of the present invention when viewed from the front side, FIG. 3 is a rear view of FIG. 2 when viewed from the rear side, FIG. 4 is a side view of FIG. 2 when viewed from the right side, and FIG. 5 is a front perspective view of FIG. 2 when viewed from the front right side. As illustrated, the coolant manifold 10 of the present invention broadly includes a base plate 100, a flow path plate 200, and a reservoir tank 300.

In this case, with reference to the indication of the directions in FIGS. 5, D11, D12, D21, D22, D31, and D32 respectively and sequentially indicate forward, rearward, leftward, rightward, upward, and downward directions based on the coolant manifold 10. In the following description, a forward/rearward direction, a leftward/rightward direction, and an upward/downward direction are based on the above-mentioned directions.

The base plate 100 may have a plate shape. The flow path plate 200 may be coupled to one surface of the base plate 100 having the plate shape. The reservoir tank may be provided at one side of the base plate 100.

More specifically, the base plate 100 may be a metal board manufactured by casting and disposed to be perpendicular to a floor surface. The base plate 100 may serve as a support so that the flow path plate 200 or the heat exchange component 700 may be mounted on and coupled to front and rear surfaces of the base plate 100.

A coolant flow path 210, through which the coolant flows, may be formed in the flow path plate 200. The flow path plate 200 may be integrated with the base plate 100 by being thermally bonded to one surface, i.e., a front or rear surface of the base plate 100. Although not illustrated separately, the flow path plate 200 includes a front flow path plate and a rear flow path plate, and the front and rear flow path plates may be respectively coupled to the front and rear surfaces of the base plate 100. However, as illustrated in FIGS. 2 to 4, in the present example, the flow path plate 200 may be configured as a rear plate and coupled to the rear surface of the base plate 100.

The reservoir tank 300 is a coolant tank having therein a hollow structure and configured to store the coolant therein. The reservoir tank 300 may be provided at one side of the base plate 100, i.e., an upper side of the base plate 100. A coolant cap 310 for supplementing the coolant may be provided on an uppermost portion of the reservoir tank 300. Because the reservoir tank 300 is disposed at the upper side of the manifold 10, it is possible to ensure the ease of operation during a process of supplementing the coolant, and the coolant stored in the tank may be easily transmitted to the coolant flow path by gravity without a separate additional component.

As described above, the coolant manifold 10 of the present invention corresponds to the reservoir tank, which stores the coolant, and the manifold in which the coolant flow path, through which the coolant flows, is integrated. The coolant module 20 of the present invention may include the coolant manifold 10.

The constituent elements will be described below in more detail.

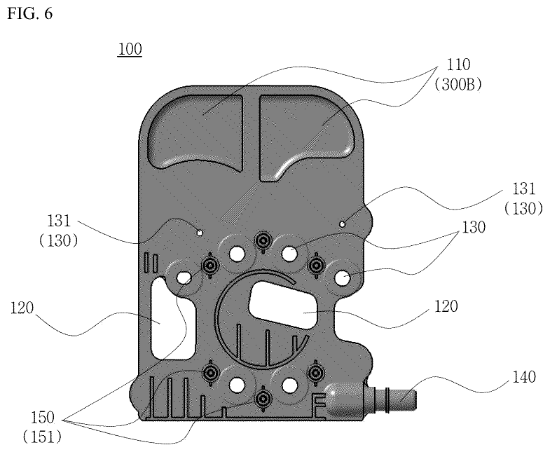

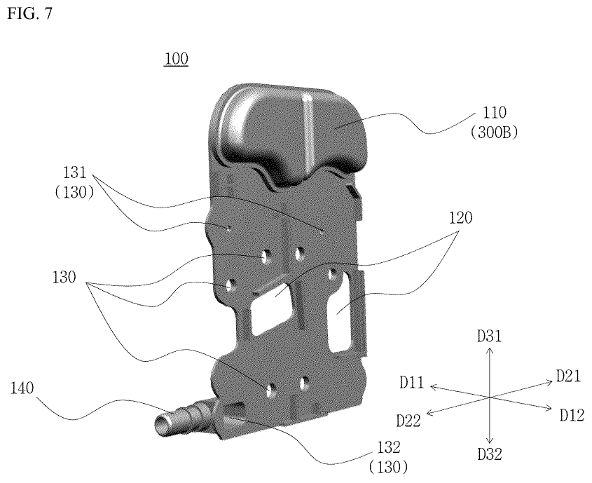

FIG. 6 is a front view illustrating the base plate according to the example of the present invention when viewed from the front side, and FIG. 7 is a rear perspective view of FIG. 6 when viewed from the rear side. The base plate 100 may have a plate shape with a predetermined area and be disposed to be perpendicular to the floor surface. The indication of the directions in FIG. 7 is consistent with the indication of the directions in FIG. 5.

The base plate 100 may include second tank parts 300B form by concavely recessing predetermined regions of the base plate 100. More specifically, recessed grooves 110, which are formed by recessing predetermined regions rearward, are formed at the upper side of the base plate 100. Therefore, a rear surface of the upper side of the base plate 100 may have a shape protruding rearward while corresponding to the recessed groove 110. The structure of the recessed groove 110 may correspond to the second tank part 300B of the reservoir tank 300 to be described below.

At least one through portion 120, which is formed through the base plate 100, may be formed in the base plate 100. The through portion may correspond to a trim portion of a mold and assist in ensuring a constant thickness of the base plate 100 and reducing the manufacturing time and the manufacturing costs. In addition, the structures, which are coupled to the front and rear surfaces of the base plate 100, may be connected directly to one another through the through portion 120, which may assist in coupling the structures and reinforcing the connectivity by using the through portion 120.

A plurality of through-holes 130, which is formed through the base plate 100, may be formed in the base plate 100. The through-hole 300 may communicate with the coolant flow path 210 in the flow path plate 200. That is, at least one side of the through-hole 300 formed in the base plate 100 may be configured to communicate with the coolant flow path 210.

In this case, with reference to FIGS. 6 and 7, at least some 131 of the plurality of through-holes 130 may be formed at a lower side of the reservoir tank 300 and communicate with an internal space of the reservoir tank 300. More specifically, as described below, the reservoir tank 300 may be divided into a first tank part 300A and the second tank part 300B, and a lower end portion of the first tank part 300A may be formed below a lower end portion of the second tank part 300B. In this case, the corresponding through-hole 131 may be formed at a lower side of the first tank part 300A and an outer lower side of the second tank part 300B and communicate with the internal space of the first tank part 300A. The through-hole 131 connected to the reservoir tank 300 may have a smaller diameter than another through-hole 130.

In addition, with respect to FIG. 7, at least one coolant inlet/outlet pipe 140, through which the coolant is introduced or discharged, may be provided on the base plate 100. In this case, the coolant inlet/outlet pipe 140 may communicate with at least one of the through-holes 130 and finally define a structure that communicates with the coolant flow path 210. The coolant inlet/outlet pipe 140 may serve to allow the coolant flow path 210 to communicate with the outside. The coolant may be discharged to the outside from the coolant flow path 210 through the coolant inlet/outlet pipe 140, or the coolant may be introduced into the coolant flow path 210 from the outside through the coolant inlet/outlet pipe 140.

In addition, mounting structures 150 may be provided on the base plate 100, and any one of the coolant control module 600 and the heat exchange component 700 may be mounted on the mounting structure 150. For example, with reference to FIGS. 5 and 6, as an example of the mounting structures 150, a plurality of mounting bosses 151 protruding forward may be provided on the front surface of the base plate 100. The coolant control module 600 may be mounted on the base plate 100 by using the plurality of mounting bosses 151.

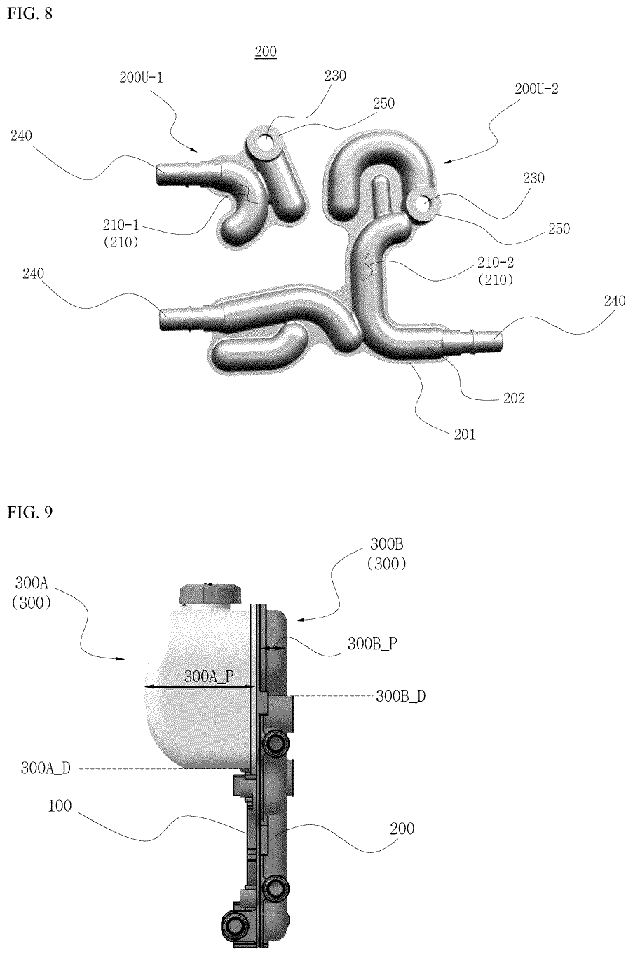

FIG. 8 is a view illustrating the flow path plate according to the example of the present invention. As illustrated, the flow path plate 200 may have a plate structure with a pipe shape in which the coolant flow path 210 is formed. Specifically, the flow path plate 200 may have a structure in which the coolant flow path 210 is debossed in a flat first flow path plate 201, and a second flow path plate 202 having a half-pipe structure with a shape convex outward is stacked on and coupled to the first flow path plate 201. That is, the first flow path plate 201 and the second flow path plate 202 are stacked on and coupled to each other, such that an empty space is formed between the first flow path plate 201 and the second flow path plate 202. The corresponding empty space may define the coolant flow path 210. As described above, the flow path plate 200 made by stacking and coupling the first and second flow path plates 201 and 202 may be configured in a shape in which the first flow path plate 201 is coupled to the base plate 100, and the second flow path plate 202 convexly protrudes outward from the base plate 100.

In addition, as illustrated in FIG. 8, the flow path plate 200 may include a plurality of unit flow path plates, i.e., a first unit flow path plate 200U-1 and a second unit flow path plate 200U-2. A first coolant flow path 210-1 may be formed in the first unit flow path plate 200U-1, and a second coolant flow path 210-2, which is fluidly separated from the first coolant flow path 210-1, may be formed in the second unit flow path plate 200U-2. That is, the flow path plate 200 of the present invention may be not only configured as a single component as a whole, but also configured as a plurality of unit structures. Further, the flow path plate 200 may include a plurality of coolant flow paths fluidly separated to define a plurality of coolant routes fluidly separated. Further, although not illustrated separately, the plurality of coolant flow paths separated from one another may be configured even in the same unit flow path plate. Of course, the plurality of coolant flow paths separated from one another may be configured in a single flow path plate without forming the plurality of unit flow path plates.

With reference to FIG. 8, at least one coolant inlet/outlet pipe 240, in which the coolant flow path 210 extends so that the coolant is introduced or discharged, may be provided in the flow path plate 200. That is, the coolant inlet/outlet pipe 240 may communicate with the coolant flow path 210. The coolant may be discharged to the outside from the coolant flow path 210 through the coolant inlet/outlet pipe 240, and the coolant may be introduced into the coolant flow path 210 from the outside through the coolant inlet/outlet pipe 240.

In addition, at least one coolant inlet/outlet port 230 may be provided in the flow path plate 200. The coolant inlet/outlet port 230 may be formed through the outer surface, i.e., the second flow path plate 202 of the flow path plate 200 and communicate with the coolant flow path 210 so that the coolant is introduced or discharged. The coolant inlet/outlet port 230 may provide a connection structure that may be connected directly to the heat exchange component 700 provided outside the flow path plate 200. Therefore, coupling structures, such as an additional valve, may be excluded, which may implement the more compact coolant module.

In addition, mounting structures 250 may be provided on the flow path plate 200, and any one of the coolant control module 600 and the heat exchange component 700 may be mounted on the mounting structure 250. For example, as illustrated in FIG. 8, the mounting structure 250 may have a flat upper surface shape, unlike the other part having a convex shape. Therefore, the mounting structure 250 may assist in tightly fixing the heat exchange component 700 to the flow path plate 200 by means of the flat upper surface of the mounting structure 250. In this case, the through-hole of the coolant inlet/outlet port 230 may be positioned at a center of the mounting structure 250. Therefore, the coolant inlet/outlet port 230 may also serve as the mounting structure 250.

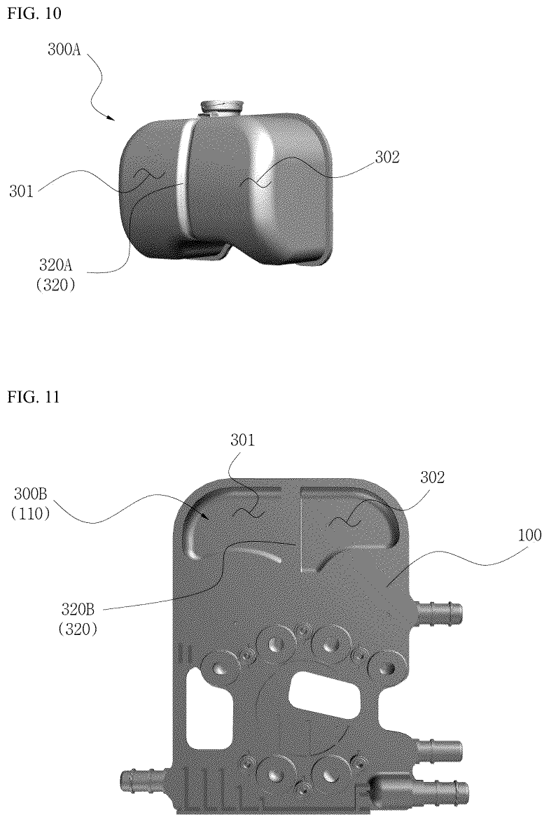

FIG. 9 is a view for explaining a reservoir tank according to the example of the present invention, FIG. 10 is a view illustrating the first tank part, and FIG. 11 is a view illustrating the second tank part. As illustrated, the reservoir tank 300 of the present invention may be disposed at the upper side of the base plate 100. In this case, the reservoir tank 300 may include the first tank part 300A and the second tank part 300B.

More specifically, with reference to FIG. 11, as described above, the recessed groove 110, which is made by concavely recessing the predetermined region, may be formed in the base plate 100, and the recessed groove 110 may correspond to the second tank part 300B. With reference to FIG. 10, the first tank part 300A may be manufactured separately from the second tank part 300B, disposed forward of the second tank part 300B, i.e., the recessed groove 110 of the base plate 100, and thermally bonded to the base plate 100.

That is, in the reservoir tank 300 of the present invention, the second tank part 300B is formed in a recessed groove shape in the base plate 100 and integrated with the base plate 100, and the first tank part 300A is coupled to the front side of the base plate by thermal bonding. The reservoir tank 300 is integrated with the coolant manifold as described above, which may further improve the effect of reducing the packaging and costs. In the present example, the first tank part 300A is disposed at the front side of the base plate 100, and the second tank part 300B is formed in the base plate 100. However, the above-mentioned configuration may be implemented in a reverse manner.

In this case, with reference to FIG. 9, a lower end portion 300A_D of the first tank part 300A may be formed below a lower end portion 300B_D of the second tank part 300B. This configuration is provided to allow the reservoir tank 300 and the coolant flow path 210 to communicate with each other. As described above, the through-hole is formed at the lower side of the first tank part 300A, i.e., below the second tank part 300B, such that the coolant flow path 210 of the flow path plate 200 and the internal space of the reservoir tank 300 may communicate with each other.

In addition, as illustrated in FIG. 9, a degree (300A_P) to which the first tank part 300A protrudes forward from the base plate 100 by a height of the internal space of the first tank part 300A in the forward/rearward direction may be larger than a degree to which the second tank part 300B protrudes rearward from the base plate 100 by a height of the internal space of the second tank part 300B in the forward/rearward direction, i.e., a degree (300B_P) to which the recessed groove 310 is recessed rearward from the base plate 100. That is, an internal volume surrounded by the first tank part 300A may be larger than an internal volume surrounded by the second tank part 300B. Because the second tank part 300B is formed by recessing the base plate 100, there is a constraint in increasing a size of the second tank part 300B. In contrast, the first tank part 300A is manufactured to be larger than the second tank part 300B and coupled to the base plate by thermal bonding, thereby overcoming the constraint and ensuring the sufficient storage capacity.

Further, the internal space of the reservoir tank 300 of the present invention may be divided into two or more spaces by a partition wall. That is, in the reservoir tank 300 of the present invention, the internal space of the tank main body 100 may be divided into a first space 301 and a second space 302 by a partition wall 320. The spaces 301 and 302, which are separated as described above, may be configured as different cooling circuits. For example, the coolant in the first space 301 may circulate through a PE cooling circuit, and the coolant in the second space 302 may circulate through a battery cooling circuit.

That is, the reservoir tank 300 of the present invention is configured by integrating separate reservoir tanks in the related art, which have been provided for respective cooling circuits to operate separate cooling circuits, into a single reservoir tank by using the partition wall 320 that bisects the internal space. Therefore, it is possible to solve the problem caused by the use of a plurality of reservoir tanks in the related art. In the present invention, the partition wall 320 of the reservoir tank 300 may, of course, include the partition wall 320A formed on the first tank part 300A, and the partition wall 320B formed on the second tank part 300B.

Hereinafter, the coolant module 20, which is configured by using the coolant manifold 10, will be described in detail.

With reference back to FIGS. 12 and 13, the coolant module 20 of the present invention may be configured by mounting the coolant control module 600 and the heat exchange component 700 in the coolant manifold 10.

As a specific example, as illustrated in FIGS. 12 and 13, the flow path plate 200 may be coupled to the rear surface of the base plate 100 by thermal bonding, and the coolant control module 600 may be mounted at the front side of the coolant manifold 10 by means of the mounting structure 150, which is provided on the base plate 100, e.g., a mounting bushing 151 described above. The condenser 710 and the chiller 720 may be mounted at the rear side of the coolant manifold 10 by means of the mounting structure 250, which is provided on the flow path plate 200, e.g., the flat upper surface structure of the coolant inlet/outlet port 230 described above.

Further, the coolant control module 600 may communicate directly with the coolant flow path 210 in the flow path plate 200 through the through-hole 130 formed in the base plate 100, and the condenser 710 and the chiller 720 may communicate directly with the coolant flow path 210 in the flow path plate 200 through the coolant inlet/outlet port 230 formed through the outer surface of the flow path plate 200 so that the coolant is introduced and discharged.

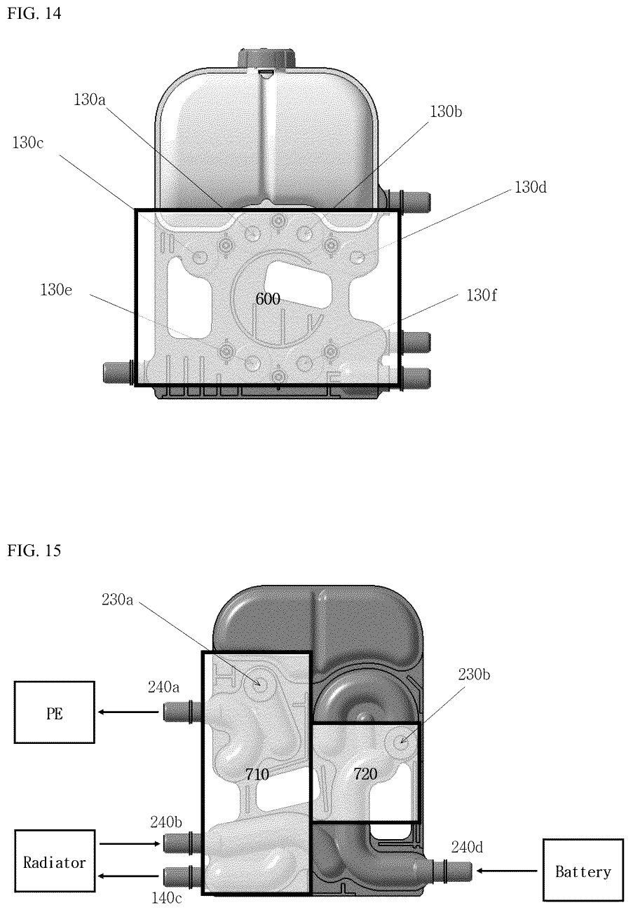

FIGS. 14 and 15 are views for explaining a flow of the coolant in the coolant module according to the example of the present invention, in which FIG. 14 illustrates a front surface of the coolant module 20, and FIG. 15 illustrates a rear surface of the coolant module 20.

As illustrated in FIG. 14, the plurality of through-holes 130 may be formed in the coolant manifold 10. In this case, all the front sides of the first to sixth through-holes 130a, 130b, 130c, 130d, 130e, and 130f may communicate with the coolant control module 600, and all the rear sides of the first to sixth through-holes 130a, 130b, 130c, 130d, 130e, and 130f may communicate with the coolant flow path 210 of the flow path plate 200.

As illustrated in FIG. 15, the coolant inlet/outlet pipes 140 and 240 and the coolant inlet/outlet ports 230 are positioned on the coolant manifold 10. In this case, a first coolant inlet/outlet port 230a may be connected directly to the condenser 710 and transfer the coolant from the condenser 710 to the coolant control module 600, a second coolant inlet/outlet port 230b may be connected directly to the chiller 720 and transfer the coolant from the chiller 720 to the coolant control module 600, a first coolant inlet/outlet pipe 240a may transfer the coolant to the external PE component, a second coolant inlet/outlet pipe 240b may transfer the coolant from an external radiator to the coolant control module 600, a third coolant inlet/outlet pipe 140c may transfer the coolant from the coolant control module 600 to the external radiator, and a fourth coolant inlet/outlet pipe 240d may transfer the coolant from an external battery to the coolant control module 600.

As described above, according to the coolant module of the present invention, hoses or pipes may be excluded or a piping length may be shortened by integrating the components that constitute the cooling system, thereby achieving the miniaturization and weight reduction and reducing the number of components of the cooling system and the number of assembling processes.

In addition, the coolant inlet or outlet may be freely configured by the coolant manifold, which may improve a degree of freedom of the assemblability. Further, the reservoir tank may be integrated with the manifold, which may improve the effect of reducing the packaging and costs.

In addition, the internal space of the reservoir tank may be divided into two spaces, and the coolant flow path of the manifold may be formed as two coolant flow paths separated from each other while corresponding to the two spaces, such that the PE cooling circuit and the battery cooling circuit may be configured only by using the single coolant module, thereby further improving the packaging properties.

While the embodiments of the present invention have been described with reference to the accompanying drawings, those skilled in the art will understand that the present invention may be carried out in any other specific form without changing the technical spirit or an essential feature thereof. Therefore, it should be understood that the above-described embodiments are illustrative in all aspects and do not limit the present invention.

### DESCRIPTION OF REFERENCE NUMERALS

20: Coolant module
10: Coolant manifold
100: Base plate
110: Recessed groove
120: Through portion
130: Through-hole
140: Coolant inlet/outlet pipe
150: Mounting structure
200: Flow path plate
200A: First unit flow path plate
200B: Second unit flow path plate
210: Coolant flow path
230: Coolant inlet/outlet port
240: Coolant inlet/outlet pipe
250: Mounting structure
300: Reservoir tank
300A: Front tank
300B: Rear tank
320): Partition wall
600: Coolant control module
610: Coolant valve
620: Coolant pump
630): Controller
700: Heat exchange component
710: Condenser
720: Chiller

1. A coolant module comprising:
a coolant manifold,
wherein the coolant manifold comprises:
a base plate having a plate shape;
a flow path plate coupled to one surface of the base plate and having a coolant flow path in which a coolant flows; and
a reservoir tank provided at one side of the base plate and having therein a hollow structure to store the coolant.

2. The coolant module of claim 1, wherein the reservoir tank is formed by coupling a first tank part and the base plate.

3. The coolant module of claim 2, wherein the base plate comprises a second tank part made by concavely recessing a predetermined region of the base plate, and the first tank part and the second tank part define one reservoir tank.

4. The coolant module of claim 3, wherein a degree to which the first tank part protrudes is larger than a degree to which the second tank part protrudes.

5. The coolant module of claim 3, wherein an internal volume surrounded by the first tank part is larger than an internal volume surrounded by the second tank part.

6. The coolant module of claim 1, wherein an internal space of the reservoir tank is divided into two or more spaces by a partition wall.

7. The coolant module of claim 1, wherein at least one through portion, which is formed through the base plate, is formed in the base plate.

8. The coolant module of claim 1, wherein at least one through-hole, which is formed through the base plate and communicates with the coolant flow path in the flow path plate, is formed in the base plate.

9. The coolant module of claim 8, wherein at least some of the through-holes are formed at a lower side of the reservoir tank and communicate with an internal space of the reservoir tank.

10. The coolant module of claim 8, wherein at least one coolant inlet/outlet pipe, through which the coolant is introduced and discharged, is provided on the base plate, and the coolant pipe communicates with at least one of the through-holes and communicates with the coolant flow path in the flow path plate.

11. The coolant module of claim 1, wherein at least one coolant inlet/outlet pipe, in which the coolant flow path in the flow path plate extends to allow the coolant to be introduced or discharged, is provided on the flow path plate.

12. The coolant module of claim 1, wherein at least one coolant inlet/outlet port, which penetrates an outer surface of the flow path plate and communicates with the coolant flow path in the flow path plate to allow the coolant to be introduced or discharged, is formed in the flow path plate.

13. The coolant module of claim 1, wherein the flow path plate comprises:
a first unit flow path plate having a first coolant flow path therein; and
a second unit flow path plate having a second coolant flow path therein, and
wherein the first coolant flow path and the second coolant flow path are separated from each other.

14. The coolant module of claim 1, wherein a mounting structure, on which a heat exchange component is mounted, is provided on at least one of the base plate and the flow path plate.

15. The coolant module of claim 1, further comprising:
heat exchange components and a coolant control module mounted in the coolant manifold in which the coolant flows.

16. The coolant module of claim 15, wherein the coolant control module comprises:
at least one coolant pump:
a coolant valve; and
a controller configured to control the coolant pump and the coolant valve.

17. The coolant module of claim 16, wherein the heat exchange components comprise a chiller and a condenser.

18. The coolant module of claim 17, wherein the flow path plate is coupled to a rear surface of the base plate,
wherein the coolant control module is mounted at a front side of the coolant manifold by means of a mounting structure provided on the base plate, and
wherein the chiller and the condenser are mounted at a rear side of the coolant manifold by means of a mounting structure provided on the flow path plate.

19. The coolant module of claim 18, wherein the coolant control module communicates directly with the coolant flow path in the flow path plate through a through-hole that is formed through the base plate and communicates with the coolant flow path, and
wherein the chiller and the condenser communicate directly with the coolant flow path in the flow path plate through a coolant inlet/outlet port that penetrates an outer surface of the flow path plate and communicates with the coolant flow path to allow the coolant to be introduced or discharged.
